(19) United States
(12) Patent Application Publication
(10) Pub. No.: US 2015/0023393 A1
(43) Pub. Date: Jan. 22, 2015

(54) Large Area Temperature Sensor

(71) Applicant: PST Sensors (Proprietary) Limited, Cape Town (ZA)

(72) Inventors: David Thomas Britton, Cape Town (ZA); Margit Harting, Cape Town (ZA)

(73) Assignee: PST Sensors (Proprietary) Limited, Cape Town (ZA)

(21) Appl. No.: 14/375,467

(22) PCT Filed: Jan. 30, 2013
(86) PCT No.: PCT/IB2013/050784

§ 371 Date: Jul. 30, 2014

(30) Foreign Application Priority Data
Jan. 30, 2012 (ZA) 2012/00771

(51) Int. Cl. G01K 7/24; G01K 1/14

(52) U.S. Cl. CPC G01K 7/24; G01K 1/14
USPC 374/185

(57) ABSTRACT

A sensing device is made up of a network of nominally identical temperature dependent resistors which is topologically equivalent to a square resistor network. The device has terminals at which an average resistance value thereof can be measured. The resistors are supported on a substrate which can be reduced in size from an initial size without substantially changing the average resistance value. In preferred embodiments, a pattern of contacts and conductive tracks joining the contacts are printed on a substrate, and a material having a temperature dependent resistance is applied over the contacts to define a network of interconnected thermistors. Alternatively, the material can be applied to the substrate first and the contacts and tracks printed on it.

### BACKGROUND OF THE INVENTION

THIS invention relates to temperature sensing devices and a method of producing such devices.

In many applications, in fields as diverse as engineering, health care, packaging and transport, it is desirable to obtain quantitative information on the temperature of a large irregularly shaped object, or of a complex structure whose shape or configuration may change under different conditions or be caused to change. Such an object may be made of thin flexible material such as fabric, polymer film or paper, or may be a rigid or ductile part composed of metal, plastic or a composite material, for example. Alternatively, a sensor may be required to determine the average temperature over a specific portion of a larger area, for example in an environmentally controlled room or chamber, or in a refrigeration unit.

A common method used for such measurements is infrared or visible thermography, in which the radiation emitted by the object is recorded by a digital camera. While having the advantage, for some applications, of being a non-contact measurement, this is often a disadvantage due to factors such as extraneous radiation, poor visibility and obscuring of the field of view, transparency of the material and variation in emissivity and reflectivity. It is therefore often desirable to utilize a sensor which is in good direct thermal contact with the object. Generally this requires either a flexible or conformable sensor which can be affixed to a non-flat surface.

Presently, when a direct temperature measurement is required, individual discrete components are mounted onto the object. The sensors used are either thermocouples or, more often, resistive devices such as thermistors.

It is an object of the invention to provide an alternative temperature sensing device which can be applied to differently sized and shaped objects to be measured.

### SUMMARY OF THE INVENTION

According to the invention there is provided a sensing device including a plurality of nominally identical temperature dependent resistors connected in series and parallel with each other to form a network which is topologically equivalent to a square resistor network, the sensing device having terminals at which an average resistance value thereof can be measured, the plurality of resistors being supported on a substrate which can be reduced in size from an initial size without substantially changing the value of the average resistance value.

In practice, the network will preferably be a square or hexagonal network.

In such a network, at any constant temperature, the resistance across any two adjacent nodes of the network is constant, and equivalent to the resistance of any one individual resistor. The temperature dependence of the resistance between adjacent nodes is the same as the temperature dependence of the individual resistors, and if there is a gradient of temperature over the area of the device, the measured resistance corresponds to a spatial average of the temperature in the area covered by the network of resistors.

The sensing device may comprise a regular pattern of electrically conductive contacts with a complemental pattern of material with a temperature dependent resistance in contact with said contacts, thereby to define a network of thermistor elements corresponding to said regular pattern.

For example, the device may comprise a network of pairs of electrically conductive contacts connected by conductive connecting tracks deposited on a substrate, with the material having a temperature dependent resistance being deposited selectively over the pairs of contacts to define thermistor elements of the device.

Conversely, the material having a temperature dependent resistance may be deposited on the substrate, with the network of pairs of electrically conductive contacts connected by electrically conductive connecting tracks being deposited thereon.

The substrate may comprise flexible sheet material such as paper sheet, a polymer film, fabric or an insulated metal foil, for example.

Alternatively the substrate may comprise a rigid material, such as any suitable stiff plastics sheet material, paper board, composite materials or coated metal sheet, for example.

The conductive contacts and tracks and the material having a temperature dependent resistance may all be formed by screen printing of a conducting ink or paste, but any known suitable printing, coating or vacuum deposition process could also be used.

In one example embodiment, a sensing device comprises a network of sets of electrically conductive contacts connected by electrically conductive tracks extending between the sets of contacts, the sets of contacts and the conductive tracks being deposited on a substrate, with a layer of material having a temperature dependent resistance being applied to each set of contacts to define a network of interconnected thermistors.

Each set of contacts may comprise two sets of interdigitated fingers extending adjacent one another, with the fingers of one set of fingers being connected to a first node of the network and the fingers of the other set of fingers being connected to a second, adjacent node of the network.

In another example embodiment, the sensing device may comprise an array of discrete contacts deposited on a suitable substrate, with a layer of material having a temperature dependent resistance being applied over the contacts to define a network of interconnected thermistors.

### BRIEF DESCRIPTION OF THE DRAWINGS

FIG. 1 is a schematic diagram showing a “square” network of identical temperature dependent resistors;

FIG. 2 is a schematic plan view of a first example embodiment of a large area printed temperature sensor array comprising a square network of individual printed thermistors; and

FIG. 3 is a schematic plan view of a second example embodiment of a large area printed temperature sensor array having a simplified structure.

### DESCRIPTION OF EMBODIMENTS

The present invention relates to temperature sensing devices and a method of producing such devices. In particular, the devices may be large area negative temperature coefficient thermistors, produced by printing techniques on thin substrates, which may be cut to size without affecting the characteristics of the device. Of particular relevance here are thermistors which have a negative temperature coefficient of resistance, commonly known as NTC thermistors, meaning that their electrical resistance decreases approximately exponentially with increasing temperature.

The present invention therefore concerns the use of thermistors, specifically printed negative temperature coefficient (NTC) thermistors, which can be applied as single large area sensor to determine an average temperature or as a temperature sensing array as described in our co-pending provisional patent application Thermal Imaging Sensor, filed on 30 Jan. 2012, where the sensors may be individually addressed or addressed as a row and column matrix. The present invention is not restricted to printed NTC thermistors, but is equally applicable to any flexible temperature sensor, the resistance of which changes with temperature, and so may equally applied to a positive temperature coefficient (FTC) thermistor or resistance temperature device (RTD), and to any such device fabricated on a flexible substrate material. Additionally, the present invention can be applied to any other type of resistive sensor, including but not limited to a piezoresistor or a photoresistor, allowing similar large area sensors for other applications such as strain and pressure sensing or the detection of visible and invisible radiation.

Existing thermistors of this general type are composed of pastes comprised of a powder of a compound semiconductor material and a binder material, such as a glass frit. This paste is either screen printed onto a ceramic substrate or cast to form a green body, after which it is sintered at high temperature to form a massive layer or body of semiconductor material. Invariably, because of distortion during the thermal treatment, further trimming of the material to obtain the correct resistance is required before metallization, in the case of thick-film thermistors.

The fabrication processes used place limitations on the substrate materials that can be used precluding the use of many lightweight, flexible materials such as paper and polymer film. Traditionally, thick-film inks used for the fabrication of thermistors are composed of heavy metal sulphides and or tellurides, such as lead sulphide, and are not compliant with modern legislation such as the European Restriction on Hazardous Substances (ROHS). Recently introduced alternative materials include compositions of mixtures of rare earth and transition metal oxides, such as manganese oxide. Thermistors based on silicon are usually cut from heavily doped silicon wafers, and have a positive temperature coefficient of resistance.

These fabrication methods are not compatible with the use of conventional thermistors in large area arrays. Therefore a printed device of the type described by us in PCT/IB2011/054001 is preferred. Depending on the requirements of the application, the substrate on which the sensor is printed may be rigid or flexible as described in our own prior art. Similarly other components of the sensor array, including but not limited to temperature independent resistors, conductive tracks and insulators may also be printed onto the substrate material. Any commonly known printing process, such as screen printing, gravure printing, flexography and ink jet printing, which are applied in the printed electronics or thick film electronics industries may be used. Alternatively discrete components may be affixed to the substrate material and connected to each other by any suitable method commonly used in the electronics assembly industry.

As an alternative to an NTC thermistor, a positive temperature coefficient (PTC) thermistor or resistance temperature device (RTD) may be used as the sensing element. The PTC thermistor may be an inorganic semiconductor of conventional art or manufactured from a semiconducting polymer as described by Panda et al in WO 2012/001465. Similarly the RTD may be manufactured according to any known method, such as forming a wire or thin film of a metal to the appropriate dimensions. Alternatively the RTD may be formed from a highly resistive printed track.

The disadvantages of using an RTD instead of a thermistor are firstly that the resistance of the RTD and its temperature dependence are comparable to that of the conductive tracks which connect the sensing elements of the network, and secondly that the relative change in resistance with temperature is small compared to that of a thermistor. However, it is well known that for a large area low resistance conductive sheet, such as could be produced from the metal comprising an RTD, that the resistance measured between any two nearby points on its surface is independent of the size and shape of the surrounding area. Hence it would not be necessary to apply the present invention to an RTD. On the other hand, in such a continuous sheet the measured resistance is much less sensitive to changes in resistance in the area outside of the space between the two points than in a discrete resistor network.

The invention described below may be similarly applied to the measurement of the average, over an extended area, of any quantity which can be used to induce a change in the electrical conductivity of the material used to form the sensing elements. Known parameters include force and strain, if the material used is piezoresistive, and light if the material exhibits photoconductivity. Alternatively, if the material can be made to interact with chemical species in its immediate environment, for example by the addition of functional groups to nanoparticles in the sensor, or a change of doping level in a semiconducting polymer, the sensor array as described below could be used to monitor chemical changes in its environment.

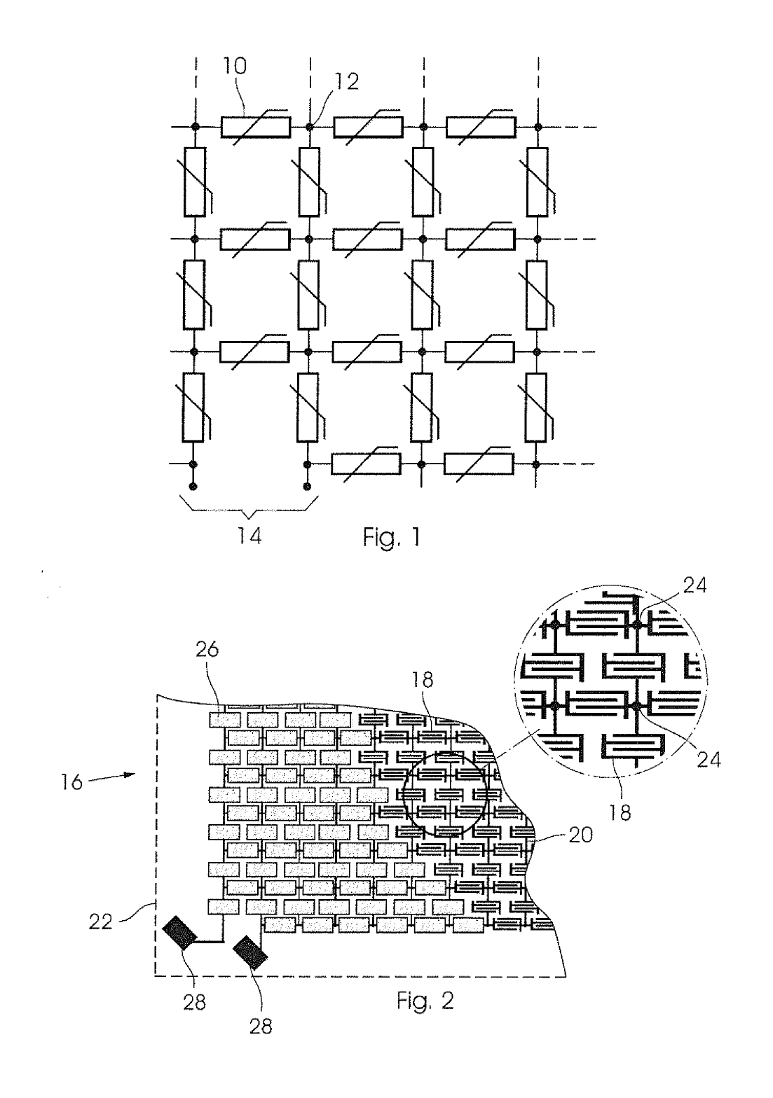

The effective circuit for a square network of resistors is shown in FIG. 1. It should be noted here that the term “square” refers to the equality of magnitude of electrical resistors and not the length of side of the connections or the angle between them. Hence any network of approximately equal resistors in which four resistors 10 connect at a node 12 can be considered to be square.

By extension of the symmetry considerations, the invention disclosed here applies equally to a rectangular network, in which two unequal sets of resistors are applied, or to a hexagonal network which has three resistors connecting at each node. More general networks with three or more unequal resistors, or with a higher number of resistors connecting at a node, are possible, but are not desirable due to the increased complexity of fabrication, with no improvement in size independence of the measured electrical resistance.

In the present invention, one resistive link may be removed from the circuit to form a pair of terminals 14 by means of which the average resistance of the network may be measured, using any method normally applied to the measurement of the value of a single resistor. Alternatively, the resistance may be determined between any two nodes 12 without removal of the intervening resistors.

For simplicity it is preferred, but not essential, to determine the resistance between two adjacent nodes. For the complete square and hexagonal networks, the effective resistance between any two adjacent nodes is one half and one third of the resistance of any one connection, respectively. When the connecting resistor is removed, as preferred, the resistance between the terminals 14 in the square network is equal to that of the connecting resistor. Similarly, for the hexagonal network, the measured resistance between the terminals 14 is one half of that of the connecting resistor 10.

If the values of the individual resistors are not exactly equal or, as in the present invention, change under the influence of an external stimulus such as temperature, the measured resistance will be a weighted average of the resistances of the individual resistors making up the network.

FIG. 2 shows a portion of a first embodiment of a printed large area temperature sensor 16 according to the present invention, in which the individual thermistor elements are fabricated according to the method and designs disclosed in PCT/IB2011/054001. A network of interdigitated pairs of contacts 18 and conductive connecting tracks 20 between them are deposited on a suitable substrate material 22. Each pair of contacts 18 comprises two sets of interdigitated fingers extending adjacent one another, with the fingers of one set of fingers being connected to a first node 24 (equivalent to the nodes 12 of FIG. 1) and the fingers of the other set of fingers being connected to a second, adjacent node 24.

in this example, the substrate used was paper sheet, but equally polymer film, fabric or an insulated metal foil could be used as a substrate if a flexible sensor is required. Alternatively any rigid substrate material, such as any plastic, paper board, composite materials or coated metal sheet, may be used. The deposition method applied in the example was screen printing of a conducting ink, but any known printing, coating or vacuum deposition process appropriate to the final application may equally be used.

A layer 26 of material with a temperature dependent resistance is then applied to each pair of contacts 18. (For clarity in the Figure, not all the interdigitated contacts 18 are shown as being covered by the layer 26 of semiconductor material.) In a preferred embodiment the semiconductor material is deposited by screen printing of an ink comprising silicon nanoparticles over the pairs of contacts 18. However, any suitable material and deposition process which is compatible with the fabrication of the contacts and other materials used may be applied. Similarly, the semiconductor material may be deposited before the contacts are deposited, and, if required, encapsulation or insulation layers may be deposited on top of the two layers, between the first layer and the substrate or in both positions. Also, instead of a temperature dependent material, any other material, the resistance of which changes under an external stimulus, such as piezoresisitive or a photoconductive material, may be used for the fabrication of different sensors such as a pressure sensor or optical sensor. To complete the device, one sensor element is excluded from the design and a pair of terminals 28 (corresponding to the pair of terminals 14 in FIG. 1) form the connection to the two nodes 24 adjacent to the missing sensor element.

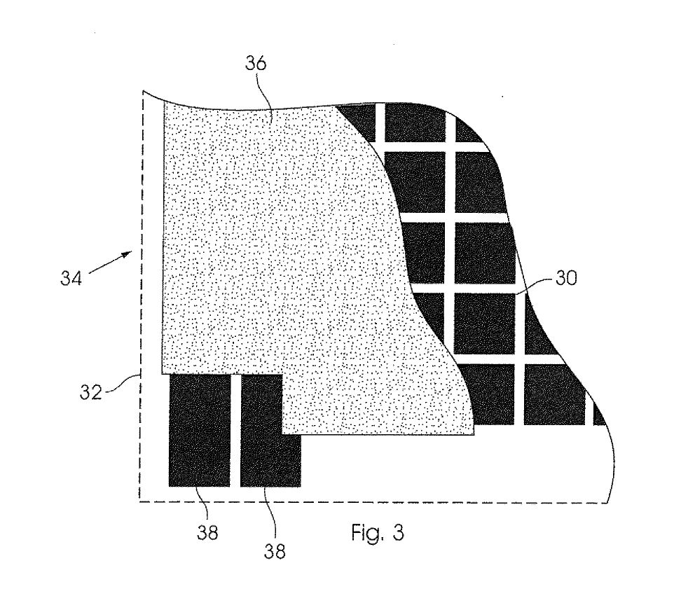

A second embodiment of the present invention, of much simpler design, is shown in FIG. 3. In this embodiment an array of discrete metallic contacts 30 is disposed in a regular pattern on a substrate 32 to define a large area temperature sensor 34. In the illustrated example the contacts 30 define a square array of square metal contacts, but equally a hexagonal arrangement of triangles may be used, or another suitable arrangement. As in the first embodiment there is no restriction on the choice of materials and fabrication process, but a flexible sheet substrate, metallic inks to define the contacts, and a conventional printing method such as screen printing are preferred.

A continuous layer 36 of semiconductor material, having a temperature dependent resistance, is deposited over the metallic contacts 30, leaving at least two of the contacts free to form a pair of terminal contacts 38. in this embodiment the connecting resistors of the device (corresponding to the resistors 10 of FIG. 1) are formed in the gaps between the parallel sides of adjacent metallic contacts, and any resistive material directly above the metallic contacts is short circuited by the contact material and does not contribute to the electrical behaviour of the device. Hence it may be desirable to deposit the semiconductor material in a grid-like pattern primarily over the gaps between the contacts 30, for example to reduce material costs or to achieve a decorative effect. Also, as in the first embodiment, the order of deposition of the conducting and semiconducting materials may be interchanged and other layers may be incorporated to provide encapsulation or electrical insulation.

1. A sensing device including a plurality of temperature dependent resistors connected in series and parallel with each other to form a network which is topologically equivalent to a square resistor network, the sensing device having terminals at which an average resistance value thereof can be measured, the plurality of resistors being supported on a substrate which can be reduced in size from an initial size without substantially changing the average resistance value.

2. The sensing device of claim 1 wherein the network is a square network of nominally identical temperature dependent resistors.

3. The sensing device of claim 1 wherein the network is a hexagonal network of nominally identical temperature dependent resistors.

4. The sensing device of claim 1 wherein the temperature dependence of the resistance between adjacent nodes of the network is the same as the temperature dependence of the individual resistors, so that when a gradient of temperature exists over the area of the device, the measured resistance corresponds to a spatial average of the temperature in the area covered by the network of resistors.

5. The sensing device of claim 1 wherein the temperature dependent resistors are negative temperature coefficient thermistors.

6. The sensing device of claim 1 comprising a regular pattern of electrically conductive contacts with a complemental pattern of material having a temperature dependent resistance in contact with said contacts, thereby to define a network of thermistor elements corresponding to said regular pattern.

7. The sensing device of claim 6 comprising a network of pairs of electrically conductive contacts connected by electrically conductive connecting tracks deposited on a substrate, with said material having a temperature dependent resistance deposited selectively over the pairs of contacts to define the thermistor elements of the device.

8. The sensing device of claim 6 wherein said material having a temperature dependent resistance is deposited on the substrate, with a network of pairs of electrically conductive contacts connected by electrically conductive connecting tracks being deposited thereon.

9. The sensing device of claim 7 wherein the substrate comprises a flexible sheet material.

10. The sensing device of claim 9 wherein the flexible sheet material is paper sheet, a polymer film, fabric or an insulated metal foil.

11. The sensing device of claim 7 wherein the substrate comprises a rigid material.

12. The sensing device of claim 11 wherein the rigid material is a stiff plastics sheet material, paper board, a composite material or a coated metal sheet.

13. The sensing device of claim 6 wherein the electrically conductive contacts and tracks and the complemental pattern of material having a temperature dependent resistance are formed by screen printing of a conducting ink or paste.

14. The sensing device of claim 1 comprising a network of sets of electrically conductive contacts connected by electrically conductive tracks extending between the sets of contacts, the sets of contacts and the conductive tracks being deposited on a substrate, with a layer of material having a temperature dependent resistance being applied to each set of contacts to define a network of interconnected thermistors.

15. The sensing device of claim 14 wherein each set of contacts comprises two sets of interdigitated fingers extending adjacent one another, with the fingers of one set of fingers being connected to a first node of the network and the fingers of the other set of fingers being connected to a second, adjacent node of the network.

16. The sensing device of claim 1 comprising an array of discrete electrically conductive contacts deposited on a substrate, with a layer of material having a temperature dependent resistance being applied over the contacts to define a network of interconnected thermistors.

17. The sensing device of claim 8 wherein the substrate comprises a flexible sheet material.

18. The sensing device of claim 8 wherein the substrate comprises a rigid material.
